(19) United States
(12) Patent Application Publication
(10) Pub. No.: US 2025/0043189 A1
(43) Pub. Date: Feb. 6, 2025

(54) PYROLYSIS METHOD AND PYROLYSIS DEVICE FOR PRODUCING PYROLYSIS GAS AND PYROLYSIS COKE

(71) Applicant: FRAUNHOFER-GESELLSCHAFT ZUR FÖRDERUNG DER ANGEWANDTEN FORSCHUNG E. V., München (DE)

(72) Inventors: Michael Artmann, Michelsneukirchen (DE); Andreas Apfelbacher, Sulzbach-Rosenberg (DE); Robert Daschner, Sulzbach-Rosenberg (DE)

(21) Appl. No.: 18/719,498

(22) PCT Filed: Dec. 20, 2022
(86) PCT No.: PCT/EP2022/087094

§ 371 Date: Jun. 13, 2024

(30) Foreign Application Priority Data
Dec. 20, 2021 (DE) 10 2021 133 899.9

(51) Int. Cl. C10B 53/02; C10B 3/02; C10B 7/10; C10K 1/00; C10K 1/02

(52) U.S. Cl. CPC C10B 53/02; C10B 3/02; C10B 7/10; C10K 1/001; C10K 1/026

(57) ABSTRACT

The invention relates to a method and a device for providing pyrolysis oil and pyrolysis gas.

### TECHNICAL FIELD

The invention relates to pyrolysis processes and pyrolysis apparatuses.

### BACKGROUND

A process for producing pyrolysis oil at process temperatures is known from DE102015108552. The process described comprises a pyrolysis step and a reforming step at 600 to 750° C. in the presence of a catalyst bed, especially a catalyst bed composed of freshly formed pyrolyzed solids. In the process, solids to be treated are introduced into a reactor tube from the top and the pyrolyzed solids are removed downward from the reactor tube, while the pyrolysis gases are removed through an inner tube for aftertreatment.

DE102014105340 discloses a process for producing pyrolysis oil with the aid of a tubular reactor, wherein the longitudinal axis of said reactor is inclined at an angle of not more than 45° relative to the horizontal plane and the material to be pyrolyzed is conveyed through the reactor by a conveying screw.

DE102016115700 likewise discloses a pyrolysis process with a reforming step at 600 to 750° C. Average particle sizes of the solid fossil fuel of 3 to 30 mm are described as being particularly suitable. The use of biogenic material is envisaged in DE102016115700 only alongside fossil fuel. Transport of the material to be treated is accomplished using conveyor belts or conveying screws, especially single-shaft extruders.

The known processes lead to plants that are relatively large and not very compact. The problem addressed was therefore that of providing a process and plant that affords pyrolysis oil but is of exceedingly compact construction and also avoids further disadvantages mentioned in the prior art, such as deposits and blockages, especially when filters are used for cleaning of the pyrolysis gases. Another problem addressed was that of providing a process that can tolerate a relatively high proportion of fines (based on the feedstock).

### SUMMARY

The present invention is based on the finding that these disadvantages can be avoided by the providing of biomass with a water content of below 30% by weight in piece form, where the median particle diameter D₅₀ of the biomass in piece form is between 2.0 mm and 60 mm (determined to ASTM E112), in combination with a pyrolysis apparatus comprising a reactor space in an essentially vertical arrangement, where the reactor space is essentially cylindrical or essentially conical, and having a conveying device for transporting the biomass in piece form from the bottom upward through the reactor space, and also feeding of the biomass in piece form from the bottom upward through the reactor space such that there is a bed within the reactor space.

In this respect, the present invention provides:
a pyrolysis process for production of pyrolysis gas and pyrolysis coke, comprising the following steps:
a) providing biomass with a water content of below 30% by weight in piece form, where the median particle diameter D₅₀ of the biomass in piece form is between 2.0 mm and 60 mm, preferably determined to ASTM E112;
b) providing a pyrolysis apparatus comprising
   i) a reactor space in an essentially vertical arrangement, where the reactor space is essentially cylindrical or essentially conical,
   ii) a conveying unit for transporting the biomass in piece form from the bottom upward through the reactor space;
   iii) a heating unit for the reactor space;
   iv) a feed for a heating medium into the heating unit from the top and a drain for said heating medium, such that the heating medium is conducted in countercurrent based on the biomass;
   v) an outlet for the pyrolysis gases in the upper region of the reactor space;
   vi) optionally a dedusting unit for the pyrolysis gases;
   vii) a discharge unit for the pyrolysis coke;
   viii) optionally a removal unit for separated dust particles;
c) feeding the biomass in piece form from the bottom upward through the reactor space such that there is a bed within the reactor space;
d) heating the biomass in piece form at a heating rate of 0.3 to 5 K/s;
e) pyrolyzing the biomass in piece form essentially in the absence of oxygen at a temperature of 400 to 750° C., preferably 450 to 650° C., for 5 to 60 minutes;
f) removing the pyrolysis gases from the reactor and optionally feeding it into the dedusting unit;
g) optionally separating off and removing dust particles
h) removing the pyrolysis coke obtained;
i) removing the pyrolysis gas
j) optionally providing pyrolysis oil by partial condensation of the pyrolysis gas removed.

The present invention further provides
a pyrolysis apparatus comprising
i) a reactor space in an essentially vertical arrangement, where the reactor space is essentially cylindrical and/or essentially conical,
ii) a conveying unit suitable for transporting biomass in piece form from the bottom upward through the reactor space so as to provide a bed of biomass;
iii) a heating unit for the reactor space
iv) a feed for a heating medium into the heating unit from the top and a drain for said heating medium, such that the heating medium is conducted in countercurrent based on the biomass; an outlet for the pyrolysis gases in the upper region of the reactor space;
v) optionally a dedusting unit for pyrolysis gases;
vi) a discharge unit for pyrolysis coke;
vii) optionally a removal unit for separated dust particles.

Biomass with a water content below 30% by weight is known and is not restricted. All kinds of biogenic waste material are possible options. A drying operation is optionally conducted. It is thus also possible to use biogenic waste materials such as sewage sludge.

The median particle diameter D₅₀ of the biomass in piece form of between 2.0 mm and 60 mm, preferably determined to ASTM E112, can be ensured by known pretreatment steps. It is especially preferable that the fines fraction, i.e. D₁₀ fraction, is present only in a percentage by weight of below 30 (based on all particles). Under some circumstances, it is necessary, for example, by means of sieve separation to adjust the average size and amount of the fines fraction. The D₁₀ fraction is preferably 10% to 30% by weight.

It is a great advantage of the present process that it is also possible to use relatively large amounts of fines, for example D₁₀ of e.g. 10% to 25% by weight, based on all particles.

The reactor space (1) is in an essentially vertical arrangement. This means that variances from exactly vertical alignment by up to 40° are possible. It is preferable that the variance from exactly vertical alignment is less than 20°. Moreover, the reactor space is essentially cylindrical and/or essentially conical. What is meant by essentially cylindrical is that variances from a circular cross-sectional area are possible. In the essentially conical embodiment, the cross-sectional area of the reactor space increases from the bottom upward. It is also possible and also preferable that the reactor space is essentially cylindrical in the middle and lower portion and is essentially conical in the upper portion. More preferably, in the embodiment with “middle and lower portion cylindrical and upper portion conical”, the middle and lower portion take up a height of 60% to 85% of the total height of the reactor space.

A further variable for influencing dwell time is the speed of the conveying unit. A conveying unit is used to transport the biomass in piece form from the bottom upward through the reactor space. This is normally a conveying screw. The conveying screw preferably takes up 80% to 95% of the cross-sectional area of the reactor space (based on the internal dimensions). This ensures that a portion of the biomass in piece form can slip downward under gravity at the inner face of the reactor shell. This ensures good mixing. The area taken up by the conveying screw is considered to be the gross area of the conveying screw including the core and any further units. The remaining ring space is thus 5% to 20% based on the cross-sectional area of the reactor interior. In the case of a conical reactor shape, the average cross-sectional area (arithmetic average) is considered correspondingly, i.e. the areas considered are the cross-sectional areas of the reactor in the region of the conveying screw.

It will usually be the case that the conveying screw does not fill the reactor space vertically, but does so only to an extent of about 60% to 85% of the total internal height of the reactor space. But there are also possible embodiments in which the conveying screw projects through the entirety of the reactor space. Typically, the height of the conveying unit is chosen such that a bed of biomass in piece form is formed above it. In other words, above the conveying screw, an accumulation is formed in the form of a bed. It will be apparent that the bed fills the entire remaining reactor space beneath, in particular the ring space discussed above. In order to assure temperatures suitable for pyrolysis and to provide appropriate amounts of heat, there is a heating unit for the reactor space. It will be apparent that the heating is effected indirectly. It is usually the case that the reactor walls are at least partly heated. The biomass in piece form is thus heated by introduction of heat from the outside: there is thus no direct contact of the biomass in piece form with the heating medium.

Additionally and preferably, there may also be a heating unit within the conveying unit, meaning that the conveying unit may optionally also be heated.

A heating medium is fed into the heating unit from the top via a feed (5), and this heating medium is removed from the heating unit via a drain (6). This means that the heating medium is conducted in countercurrent based on the biomass.

The heating medium may be gaseous. Alternatively, the heating medium may be a liquid metal or liquid metal alloy. In a preferred embodiment, the heating medium is a liquid salt melt.

The biomass in piece form is heated at a heating rate of 0.3 to 5 K/s, i.e. relatively rapidly. This is followed by pyrolysis essentially in the absence of oxygen at a temperature of 400 to 750° C., preferably 450 to 650° C., for 5 to 60 minutes. The temperature range of 400 to 750° C. means that the pyrolysis temperature is within this range. The bed will thus have a temperature from this range in the upper region, preferably in particular in the accumulation above the conveying screw.

Temperatures higher than 750° C. should absolutely be avoided. Otherwise, coking problems cannot be ruled out.

Optionally and preferably, there is a dedusting unit (8) for the pyrolysis gases.

Preference is given to using a cyclone. Additionally or alternatively, it is possible to use hot gas filters.

It is particularly preferable that the dedusting unit (8) is disposed within the reactor space (1), most preferably at the upper end of the reactor space. This has the great advantage that the dedusting unit is heated together with the reactor space, meaning that this integral solution leads to simplification and to greater compactness. A further advantage arises from the fact that the dust separated out can be removed directly with the pyrolysis coke, meaning that there is again no need for a separate removal, i.e. compactness is maximized.

In an alternative embodiment, the dedusting unit may alternatively be disposed outside the reactor space.

The pyrolysis coke obtained is removed, advantageously under gravity. It is particularly preferable to combine the pyrolysis coke obtained with the separated dust particles. As elucidated above, this is possible in a particularly simple manner when the dedusting unit is disposed at the upper end of the reactor space.

The pyrolysis oil is obtained from the pyrolysis gas by optional partial condensation.

The pyrolysis oil can preferably be obtained here by partial condensation of the pyrolysis gas removed as a biphasic mixture of pyrolysis oil and water. The biphasic mixture can be separated, for example, by removal of the phases by suction. The phase boundary can be determined by customary measurement parameters such as conductivity, refractive index and the like.

Advantageously, the pyrolysis coke is discharged under gravity. This enables a particularly compact design because there is no need for further conveying elements. Compactness is additionally assisted when the separated dust particles are combined with the pyrolysis coke, which is preferred.

When the dedusting unit is provided outside the reactor space, the discharge conduit for the dusts may also be combined with the discharge conduit for the pyrolysis coke.

In the process according to the present invention, the feeding of the biomass in piece form from the bottom upward through the reactor space is effected preferably with a conveying screw and more preferably at 0.5 to 20 revolutions per minute.

In the process of the present invention, the pyrolysis gases are preferably prepurified by the bed of biomass in piece form.

In the process according to the present invention, the screw pitch of the conveying screw preferably decreases from the top downward. This means that the distances between the screw flights becomes smaller in that direction. This creates a gradient based on the packing density of the bed: in the upper region, the density of the bed is lower compared to the packing density in the lower region. In this way, rises in pressure in the reaction region are avoided.

The bed height in the reactor space is chosen so as to achieve a dwell time of the biomass within the reactor space at a temperature of 400 to 750° C., preferably 450 to 650° C., of 5 to 60 minutes.

It should preferably be assured that there is continuous mixing of the biomass and especially of the bed thereof in the reactor space. More preferably, the continuous mixing of the biomass in piece form is provided by means of the conveying unit, meaning that the conveying unit serves simultaneously for conveying and for mixing.

The conveying unit is preferably configured such that the bed of biomass is partly mixed from the top downward, more preferably such that the bed of biomass can partly move vertically downward close to the shell surface, in particular close to the shell surface and under gravity.

The process according to the present invention is also suitable for production of hydrogen from the pyrolysis gas. The amount of hydrogen can be maximized by additionally introducing water.

In the pyrolysis apparatus described here, external heating is preferably provided, preferably with heating of the outer concluding face of the reactor or additionally of the conveying unit. What is meant by external heating is that the heat is fed in from other apparatuses and processes. Typically, synthesis gas or waste heat from other high-temperature processes will be used. It is possible and also preferable that heat is recovered from the heat flow that remains after heating of the reactor and/or heating of the conveying unit. The heat still present may advantageously be used for the preheating of air in a coupled process.

It may be the case that either the heat transfer for heating of the reactor and/or the conveying unit is direct or that a further heat transferer such as a liquid salt melt or a liquid metal or a liquid metal alloy is used. The same applies to the recovery of heat.

For reactor heating, the heating medium is preferably fed in from the top in order to ensure countercurrent conditions (based on heating medium versus biomass).

Also disclosed here is the use of the process and/or apparatus for production of biocoke, activated carbon and/or barbecue charcoal.

### DETAILED DESCRIPTION

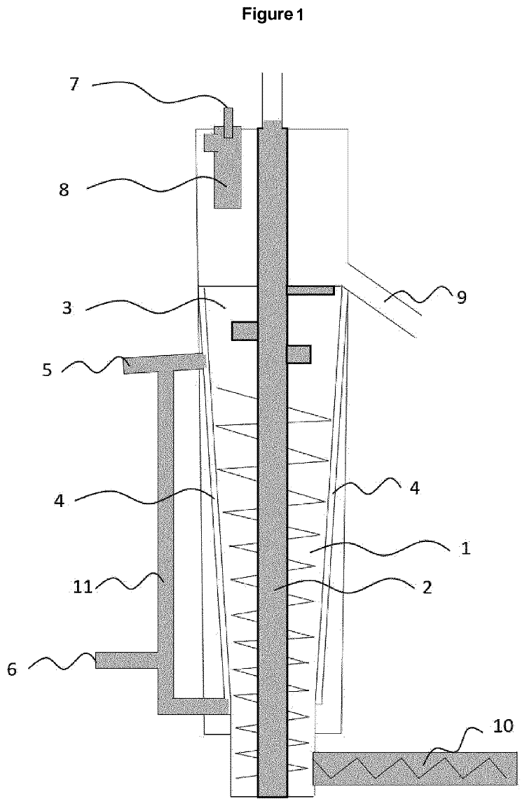

There follows a description of preferred embodiments with reference to FIG. 1.

FIG. 1 shows a section through a pyrolysis apparatus according to the present invention.

### LIST OF REFERENCE NUMERALS

1 reactor space in vertical arrangement (cylindrical and/or conical)
2 conveying unit (conveying screw) for transport of biomass in piece form from the bottom upward through the reactor space
3 bed of biomass
4 heating unit
5 feed for a heating medium into the heating unit from the top
6 drain for the heating medium
7 outlet for the pyrolysis gases
8 dedusting unit for pyrolysis gases
9 discharge unit for pyrolysis coke (and separated dust particles)
10 introduction of biomass
11 recuperator (for preheating of air from waste air)

In the embodiment shown, the reactor space (1) is conical. The reactor space has an internal conveying screw (2). With the aid of this conveying screw, the biomass is transported from the bottom upward and is also simultaneously mixed and loosened. The biomass is in the form of a loose bed (3). The reactor space (1) is heated by means of a heating unit (4). This heating unit (4) may be designed as a simple jacket construction or else in the form of piping on or optionally within the reactor wall. The heating medium, e.g. gas, is fed in from the top via the feed (5). The heating medium leaves the reactor wall again in the lower region of the reactor. The biomass is conveyed from the bottom upward, while the heating medium is conveyed from the top downward, i.e. the heating is effected in countercurrent.
The conveying screw (2) does not fill the reactor space completely, but only to an extent of 80% to 95%, based on the cross-sectional area. The biomass in piece form is in the form of a bed (3), with constant mixing of this bed (3). The feeding of the biomass in piece form is effected via the unit (10). In addition, the bed (3) serves as a preliminary filter for the pyrolysis gases. There is a dedusting unit in the upper portion of the reactor space. The pyrolysis gases are fed into this dedusting unit (8) and cleaned. The dedusting unit is preferably designed as a cyclone. The dusts separated off may fall onto the bed under gravity and be removed together with the pyrolysis coke obtained. For this purpose, there is a discharge unit (9) for the pyrolysis coke. This is preferably designed such that the pyrolysis coke is removed under gravity. It is particularly advantageous that the dust particles separated out can likewise be removed via this discharge unit.

### EXPERIMENTAL SECTION

An experimental plant was projected and tested. It was found that no blocking problems occur, and that excellent compactness is achieved.

### Embodiments

1. A pyrolysis process for production of pyrolysis gas and pyrolysis coke, comprising the following steps:
a) providing biomass with a water content of below 30% by weight in piece form, where the median particle diameter D₅₀ of the biomass in piece form is between 2.0 mm and 60 mm, preferably determined to ASTM E112;
b) providing a pyrolysis apparatus comprising
   i) a reactor space (1) in an essentially vertical arrangement, where the reactor space is essentially cylindrical and/or essentially conical,
   ii) a conveying unit (2) for transporting the biomass in piece form from the bottom upward through the reactor space;
   iii) a heating unit (4) for the reactor space;
   iv) a feed (5) for a heating medium into the heating unit from the top and a drain (6) for said heating medium, such that the heating medium is conducted in countercurrent based on the biomass;
   v) an outlet (7) for the pyrolysis gases in the upper region of the reactor space;
   vi) optionally a dedusting unit (8) for the pyrolysis gases;
   vii) a discharge unit (9) for pyrolysis coke or a discharge unit (9) for pyrolysis coke and separated dust particles;
c) feeding the biomass in piece form from the bottom upward through the reactor space (1), such that there is a bed (3) within the reactor space;
d) heating the biomass in piece form at a heating rate of 0.3 to 5 K/s;
e) pyrolyzing the biomass in piece form essentially in the absence of oxygen at a temperature of 400 to 750° C., preferably 450 to 650° C., for 5 to 60 minutes;
f) removing the pyrolysis gases from the reactor and optionally feeding it into the dedusting unit;
g) optionally separating off and removing dust particles
h) removing the pyrolysis coke obtained, optionally together with the separated dust particles;
i) removing the pyrolysis gas;
h) optionally providing pyrolysis oil by partial condensation of the pyrolysis gas removed.

2. The process according to embodiment 1, wherein pyrolysis oil is obtained by partial condensation of the pyrolysis gas removed as a biphasic mixture of pyrolysis oil and water, and this biphasic mixture is separated.

3. The process according to embodiment 1 or 2, wherein the dust particles are separated off by cyclone and/or HG filter.

4. The process according to any of the preceding embodiments, wherein the pyrolysis coke is discharged under gravity.

5. The process according to any of the preceding embodiments, wherein the separated dust particles are removed together with the pyrolysis coke.

6. The process according to any of the preceding embodiments, wherein the feeding of the biomass in piece form from the bottom upward through the reactor space is effected with a conveying screw, preferably at 0.5 to 20 revolutions per minute.

7. The process according to embodiment 6, wherein the screw pitch of the conveying screw decreases from the top downward.

8. The process according to any of the preceding embodiments, wherein the pyrolysis gases are prepurified by the bed of biomass in piece form.

9. The process according to any of the preceding embodiments, wherein the bed of biomass in the upper region of the reactor space has lower bulk density than in the lower region of the reactor space.

10. The process according to any of the preceding embodiments, wherein the bed height in the reactor space is chosen so as to achieve a dwell time of the biomass within the reactor space at a temperature of 400 to 750° C., preferably 450 to 650° C., of 5 to 60 minutes.

11. The process according to any of the preceding embodiments, wherein continuous mixing of the biomass in piece form is effected by means of the conveying unit for transport of the biomass in piece form from the bottom upward through the reactor space.

12. The process according to embodiment 11, wherein the conveying unit is configured such that the bed of biomass is partly mixed from the top downward, preferably in that the bed of biomass can move vertically downward close to the shell surface, most preferably close to the shell surface and under gravity.

13. The process according to any of the preceding embodiments, wherein hydrogen is obtained from the pyrolysis gas.

14. The process according to embodiment 13, wherein water is additionally introduced.

15. A pyrolysis apparatus comprising
i) a reactor space (1) in an essentially vertical arrangement, where the reactor space is essentially cylindrical and/or essentially conical,
ii) a conveying unit (2) suitable for transporting biomass in piece form from the bottom upward through the reactor space so as to provide a bed (3);
iii) a heating unit (4) for the reactor space
iv) a feed (5) for a heating medium into the heating unit from the top and a drain (6) for said heating medium, such that the heating medium is conducted in countercurrent based on the biomass;
v) an outlet (7) for the pyrolysis gases in the upper region of the reactor space;
vi) optionally a dedusting unit (8) for pyrolysis gases;
vii) a discharge unit (9) for pyrolysis coke or optionally a discharge unit (9) for pyrolysis coke and separated dust particles.

16. The pyrolysis apparatus according to embodiment 15 with external heating, wherein preferably the outer concluding face of the reactor or the outer concluding face of the reactor and the conveying unit are heated.

17. The pyrolysis apparatus according to embodiment 15 or 16, wherein the heating medium is fed in from the top.

18. The pyrolysis apparatus according to any of embodiments 15, 16 or 17, wherein the heating medium is gaseous or the heating medium is a liquid metal or a liquid metal alloy, or the heating medium is a liquid salt melt.

19. The use of the process according to embodiments 1 to 14 and/or use of the apparatus according to embodiments 15 to 18 for production of biocoke, activated carbon and/or barbecue charcoal.

1. A pyrolysis process for production of pyrolysis gas and pyrolysis coke, comprising:
a) providing biomass with a water content of below 30% by weight in piece form, where the median particle diameter D₅₀ of the biomass in piece form is between 2.0 mm and 60 mm, determined to ASTM E112;
b) providing a pyrolysis apparatus comprising:
i) a reactor space in an essentially vertical arrangement, where the reactor space is essentially cylindrical and/or essentially conical,
ii) a conveying unit for transporting the biomass in piece form from the bottom upward through the reactor space;
iii) a heating unit for the reactor space;
iv) a feed for a heating medium into the heating unit from the top and a drain for the heating medium, such that the heating medium is conducted in countercurrent based on the biomass;
v) an outlet for the pyrolysis gases in the upper region of the reactor space;
vi) a discharge unit for pyrolysis coke or a discharge unit for pyrolysis coke and separated dust particles;
c) feeding the biomass in piece form from the bottom upward through the reactor space, such that there is a bed within the reactor space;
d) heating the biomass in piece form at a heating rate of 0.3 to 5 K/s;
e) pyrolyzing the biomass in piece form essentially in the absence of oxygen at a temperature of 400 to 750° C. for 5 to 60 minutes;
f) removing the pyrolysis gases from the reactor;
h) removing the pyrolysis coke obtained; and
i) removing the pyrolysis gas.

2. The process as claimed in claim 1, wherein the pyrolysis apparatus further comprises:
vii) a dedusting unit for the pyrolysis gases.

3. The process as claimed in claim 1, wherein step h) of the process further comprises the feeding of the pyrolysis gases into a dedusting unit.

4. The process as claimed in claim 1, wherein the process further comprises:
g) separating off and removing dust particles; where step h) further comprises the removing of the pyrolysis coke obtained together with the separated dust particles.

5. The process as claimed in claim 1, wherein the process further comprises:
i) providing pyrolysis oil by partial condensation of the pyrolysis gas removed.

6. The process as claimed in claim 1, wherein step e) consists of pyrolyzing the biomass in piece form essentially in the absence of oxygen at a temperature of 450 to 650° C., for 5 to 60 minutes.

7. The process as claimed in claim 1, wherein pyrolysis oil is obtained by partial condensation of the pyrolysis gas removed as a biphasic mixture of pyrolysis oil and water, and this biphasic mixture is separated.

8. The process as claimed in claim 1, wherein the dust particles are separated off by cyclone and/or hot gas filter.

9. The process as claimed in claim 1, wherein the pyrolysis coke is discharged under gravity.

10. The process as claimed in claim 1, wherein the separated dust particles are removed together with the pyrolysis coke.

11. The process as claimed in claim 1, wherein the feeding of the biomass in piece form from the bottom upward through the reactor space is effected with a conveying screw, preferably at 0.5 to 20 revolutions per minute.

12. The process as claimed in claim 11, wherein the screw pitch of the conveying screw decreases from the top downward.

13. The process as claimed in claim 1, wherein the pyrolysis gases are prepurified by the bed of biomass in piece form.

14. The process as claimed in claim 1, wherein the bed of biomass in the upper region of the reactor space has lower bulk density than in the lower region of the reactor space.

15. The process as claimed in claim 1, wherein the bed height in the reactor space is chosen so as to achieve a dwell time of the biomass within the reactor space at a temperature of 400 to 750° C., of 5 to 60 minutes.

16. The process as claimed in claim 1, wherein continuous mixing of the biomass in piece form is effected by means of the conveying unit for transport of the biomass in piece form from the bottom upward through the reactor space.

17. The process as claimed in claim 16, wherein the conveying unit is configured such that the bed of biomass is partly mixed from the top downward, preferably in that the bed of biomass can move vertically downward close to the shell surface, most preferably close to the shell surface and under gravity.

18. The process as claimed in claim 1, wherein hydrogen is obtained from the pyrolysis gas.

19. The process as claimed in claim 18, wherein water is additionally introduced.

20. A pyrolysis apparatus comprising:
i) a reactor space in an essentially vertical arrangement, where the reactor space is essentially cylindrical and/or essentially conical,
ii) a conveying unit suitable for transporting biomass in piece form from the bottom upward through the reactor space so as to provide a bed;
iii) a heating unit for the reactor space;
iv) a feed for a heating medium into the heating unit from the top and a drain for said heating medium, such that the heating medium is conducted in countercurrent based on the biomass;
v) an outlet for the pyrolysis gases in the upper region of the reactor space; and
vi) a discharge unit for pyrolysis coke.

21. The pyrolysis apparatus as claimed in claim 20, wherein the pyrolysis apparatus further comprises:
vii) a dedusting unit for the pyrolysis gases.

22. The pyrolysis apparatus as claimed in claim 20, comprising external heating, wherein preferably the outer concluding face of the reactor or the outer concluding face of the reactor and the conveying unit are heated.

23. The pyrolysis apparatus as claimed in claim 20, wherein the heating medium is fed in from the top.

24. The pyrolysis apparatus as claimed in claim 20, wherein the heating medium is gaseous or the heating medium is a liquid metal or a liquid metal alloy, or the heating medium is a liquid salt melt.

25. (canceled)
